(19) United States
(12) Patent Application Publication
(10) Pub. No.: US 2011/0022390 A1
(43) Pub. Date: Jan. 27, 2011

(54) SPEECH DEVICE, SPEECH CONTROL PROGRAM, AND SPEECH CONTROL METHOD

(75) Inventors: Kinya Otani, Osaka (JP); Naoki Hirose, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 12/933,302

(22) PCT Filed: Feb. 4, 2009
(86) PCT No.: PCT/JP2009/051867

§ 371 Date: Sep. 17, 2010

(30) Foreign Application Priority Data
Mar. 31, 2008 (JP) 2008-091803

(51) Int. Cl. G10L 13/08; G10L 15/00; G10L 13/00

(52) U.S. Cl. 704/246; 704/260; 704/E15.001; 704/E13.002

(57) ABSTRACT

In order to speak numerals in a manner readily comprehensible to a user, a speech device includes a voice synthesis portion 55 which, when a given character string includes a numeral made up of a plurality of digits, speaks the numeral in either a first speech method in which the numeral is read aloud as individual digits or a second speech method in which the numeral is read aloud as a full number, a user definition table 81, an association table 83, a region table 84, and a digit number table 87 which associate a type of a character string with either the first speech method or the second speech method, a process executing portion 53 which executes a process to thereby output data, and a speech control portion 51 which generates a character string on the basis of the output data and causes the voice synthesis portion 55 to speak the generated character string in one of the first and second speech methods that is associated with the type of the output data.

### TECHNICAL FIELD

The present invention relates to a speech device, a speech control program, and a speech control method. More particularly, the present invention relates to a speech device having a voice synthesis function, and a speech control program and a speech control method executed in the speech device.

### BACKGROUND ART

There has recently appeared a navigation device provided with a voice synthesis function. The voice synthesis function is a function of converting a text into a voice or speech, which is called TTS (Text To Speech). Meanwhile, there are two ways of speaking a numerical character string: one in which the numeral is spoken as individual digits, and the other in which the numeral is spoken as a full number. In the case of causing a navigation device to vocalize a numerical character string, it is critical in which way to cause it to speak the numeral. For example, a telephone number is preferably spoken as individual digits, whereas a distance is preferably spoken as a full number. Japanese Patent Application Laid-Open No. 09-006379 discloses a voice rule synthesis device which determines whether there is an expression indicating that the character string containing a numeral represents a telephone number, and if so, it performs voice synthesis such that the individual digits of the numeral are spoken one by one.

With this conventional voice rule synthesis device, only the telephone numbers are spoken as individual digits by the navigation device, while the other numerical character strings, for example the addresses, road numbers, and others, are all spoken as full numbers. The resultant voice output may be difficult for a driver to comprehend.

[Patent Document 1] Japanese Patent Application Laid-Open No. 09-006379

### DISCLOSURE OF THE INVENTION

### Problems to be Solved by the Invention

The present invention has been accomplished to solve the above-described problems, and an object of the present invention is to provide a speech device capable of speaking numerals in a manner readily comprehensible to a user.

Another object of the present invention is to provide a speech control program which allows numerals to be spoken in a manner readily comprehensible to a user.

A further object of the present invention is to provide a speech control method which allows numerals to be spoken in a manner readily comprehensible to a user.

### Means for Solving the Problems

To achieve the above-described objects, according to an aspect of the present invention, a speech device includes: speech means, in the case where a given character string includes a numeral made up of a plurality of digits, for speaking the numeral in either a first speech method in which the individual digits of the numeral are read aloud one by one or a second speech method in which the numeral is read aloud as a full number; associating means for associating a type of a character string with either the first speech method or the second speech method; process executing means for executing a predetermined process to thereby output data; and speech control means for generating a character string on the basis of the output data and causing the speech means to speak the generated character string in one of the first and second speech methods that is associated with the type of the output data.

According to this aspect, a type of a character string is associated with either the first speech method or the second speech method. A character string is generated on the basis of data that is output when a predetermined process is executed, and the character string is spoken in the speech method that is associated with the type of the output data. As such, the character string is spoken using the speech method that is predetermined for the type of the data. It is thus possible to provide the speech device capable of speaking numerals in a manner readily comprehensible to a user.

Preferably, the speech device further includes: voice acquiring means for acquiring a voice; voice recognizing means for recognizing the acquired voice to output a character string; and speech method discriminating means, in the case where the output character string includes a numeral, for discriminating one of the first and second speech methods; wherein the process executing means executes a process that is based on the character string being output, and the associating means includes registration means for associating the type of the character string being output, which is determined on the basis of the process executed by the process executing means, with a discrimination result by the speech method discriminating means.

According to this aspect, in the case where a character string output by recognizing an acquired voice includes a numeral, the first or second speech method is discriminated, and the type of the character string determined in accordance with the process that is based on the character string being output is associated with the discriminated speech method. This allows a character string of the same type as that included in the input voice to be spoken in the same speech method as that of the input voice.

According to another aspect of the present invention, a speech method includes: speech means, in the case where a given character string includes a numeral made up of a plurality of digits, for speaking the numeral in either a first speech method in which the individual digits of the numeral are read aloud one by one or a second speech method in which the numeral is read aloud as a full number; determining means for determining one of the first and second speech methods on the basis of the number of digits in a numeral included in a character string; and speech control means for causing the speech means to speak the numeral in the determined one of the first and second speech methods.

According to this aspect, in the case where a character string includes a numeral made up of a plurality of digits, one of the first and second speech methods is determined on the basis of the number of digits in the numeral included in the character string, and the character string is spoken using the determined speech method. The speech method is determined in accordance with the number of digits in the numeral. It is thus possible to provide the speech device capable of speaking numerals in a manner readily comprehensible to a user.

According to a further aspect of the present invention, a speech control program causes a computer to execute the steps of: associating either a first speech method in which a numeral made up of a plurality of digits is read aloud as individual digits or a second speech method in which a numeral made up of a plurality of digits is read aloud as a full number with a type of a character string; outputting data by executing a predetermined process; generating a character string on the basis of the output data; and speaking the generated character string in one of the first and second speech methods that is associated with the type of the output data.

According to this aspect, it is possible to provide the speech control program which allows numerals to be spoken in a manner readily comprehensible to a user.

According to a still further aspect of the present invention, a speech control program causes a computer to execute the steps of: speaking a numeral made up of a plurality of digits in a first speech method in which the individual digits of the numeral are read aloud one by one; speaking a numeral made up of a plurality of digits in a second speech method in which the numeral is read aloud as a full number; determining one of the first and second speech methods on the basis of the number of digits in a numeral included in a character string; and in the case where a given character string includes a numeral made up of a plurality of digits, causing the character string to be spoken in the determined one of the first and second speech methods.

According to yet another aspect of the present invention, a speech control method includes the steps of: associating either a first speech method in which a numeral made up of a plurality of digits is read aloud as individual digits or a second speech method in which a numeral made up of a plurality of digits is read aloud as a full number with a type of a character string; outputting data by executing a predetermined process; generating a character string on the basis of the output data; and speaking the generated character string in one of the first and second speech methods that is associated with the type of the output data.

According to this aspect, it is possible to provide the speech control method which allows numerals to be spoken in a manner readily comprehensible to a user.

According to a still further aspect of the present invention, a speech control method includes the steps of: speaking a numeral made up of a plurality of digits in a first speech method in which the individual digits of the numeral are read aloud one by one; speaking a numeral made up of a plurality of digits in a second speech method in which the numeral is read aloud as a full number; determining one of the first and second speech methods on the basis of the number of digits in a numeral included in a character string; and in the case where a given character string includes a numeral made up of a plurality of digits, causing the character string to be spoken in the determined one of the first and second speech methods.

### BRIEF DESCRIPTION OF THE DRAWINGS

FIG. 1 is a block diagram showing, by way of example, a hardware configuration of a navigation device according to an embodiment of the present invention.

FIG. 2 is a functional block diagram showing, by way of example, functions of a CPU included in the navigation device.

FIG. 3A shows an example of a user definition table.

FIG. 3B shows an example of an association table.

FIG. 3C shows an example of a region table.

FIG. 3D shows an example of a digit number table.

FIG. 4 is a flowchart illustrating, by way of example, a flow of a speech control process.

FIG. 5 is a flowchart illustrating, by way of example, a flow of an association table updating process.

### DESCRIPTION OF THE REFERENCE CHARACTERS

1: navigation device; 11: CPU; 13: GPS receiver; 15: gyroscope; 17: vehicle speed sensor; 19: memory I/F; 19A: memory card; 21: serial communication I/F; 23: display control portion; 25: LCD; 27: touch screen; 29: microphone; 31: speaker; 33: ROM; 35: RAM; 37: EEPROM; 39: operation keys; 51: speech control portion; 53: process executing portion; 55: voice synthesis portion; 57: voice output portion; 59: position acquiring portion; 61: character string generating portion; 63: speech method determining portion; 71: voice acquiring portion; 73: voice recognition portion; 75: speech method discriminating portion; 77: registration portion; 81: user definition table; 83: association table; 85: region table; and 87: digit number table.

### BEST MODES FOR CARRYING OUT THE INVENTION

Embodiments of the present invention will now be described with reference to the drawings. In the following description, like reference characters denote like members, which have like names and functions, and therefore, detailed description thereof will not be repeated.

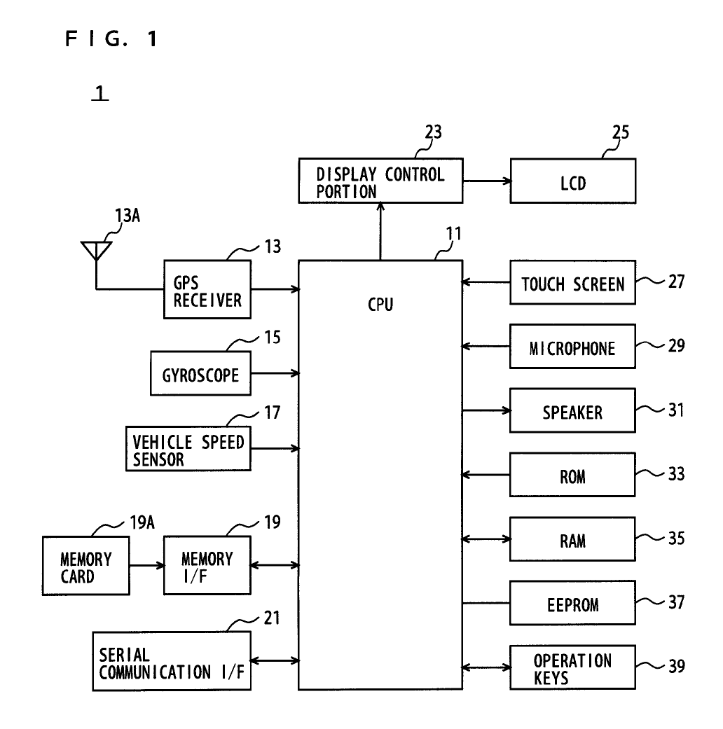

FIG. 1 is a block diagram showing, by way of example, a hardware configuration of a navigation device according to an embodiment of the present invention. Referring to FIG. 1, a navigation device 1 includes: a central processing unit (CPU) 11 which is responsible for overall control of navigation device 1; a GPS receiver 13; a gyroscope 15; a vehicle speed sensor 17; a memory interface (I/F) 19; a serial communication I/F 21; a display control portion 23; a liquid crystal display (LCD) 25; a touch screen 27; a microphone 29; a speaker 31; a read only memory (ROM) 33 for storing a program to be executed by CPU 11 and others; a random access memory (RAM) 35 which is used as a work area for CPU 11; an electrically erasable and programmable ROM (EEPROM) 37 which stores data in a non-volatile manner, and operation keys 39.

GPS receiver 13 receives radio waves from a GPS satellite in the global positioning system (GPS), to measure a current location on a map. GPS receiver 13 outputs the measured position to CPU 11.

Gyroscope 15 detects an orientation of a vehicle on which navigation device 1 is mounted, and outputs the detected orientation to CPU 11. Vehicle speed sensor 17 detects a speed of the vehicle on which the navigation device is mounted, and outputs the detected speed to CPU 11. It is noted that vehicle speed sensor 17 may be mounted on the vehicle, in which case CPU 11 receives the speed of the vehicle from vehicle speed sensor 17 mounted on the vehicle.

Display control portion 23 controls LCD 25 to cause it to display an image. LCD 25 is of a thin film transistor (TFT) type, and is controlled by display control portion 23 to display an image output from display control portion 23. It is noted that LCD 25 may be replaced with an organic electro-luminescence (EL) display.

Touch screen 27 is made up of a transparent member, and is provided on a display surface of LCD 25. Touch screen 27 detects a position on the display surface of LCD 25 designated by a user with the finger or the like, and outputs the detected position to CPU 11. CPU 11 displays various buttons on LCD 25, and accepts various operations in accordance with combinations with the designated positions detected by the touch screen. Operation screens displayed on LCD 25 by CPU 11 include an operation screen for operating navigation device 1. Operation keys 39 are button switches, which include a power key for switching on/off a main power supply.

Memory I/F 19 is mounted with a removable memory card 19A. CPU 11 reads map data stored in memory card 19A, and displays on LCD 25 an image of a map on which the current location input from GPS receiver 13 and the orientation detected by gyroscope 15 are marked. Further, CPU 11 displays on LCD 25 the image of the map on which the position of the mark moves as the vehicle moves, on the basis of the vehicle speed and the orientation input from vehicle speed sensor 17 and gyroscope 15, respectively.

While it is here assumed that the program to be executed by CPU 11 is stored in ROM 33, the program may be stored in memory card 19A and read from memory card 19A for execution by CPU 11. The recording medium for storing the program is not restricted to memory card 19A. It may be a flexible disk, a cassette tape, an optical disk (compact disc-ROM (CD-ROM), magnetic optical disc (MO), mini disc (MD), digital versatile disc (DVD)), an IC card (including a memory card), an optical card, or a semiconductor memory such as a mask ROM, an EPROM, an EEPROM, or the like.

Still alternatively, a program may be read from a computer connected to serial communication I/F 21, to be executed by CPU 11. As used herein, the “program” includes, not only the program directly executable by CPU 11, but also a source program, a compressed program, an encrypted program, and others.

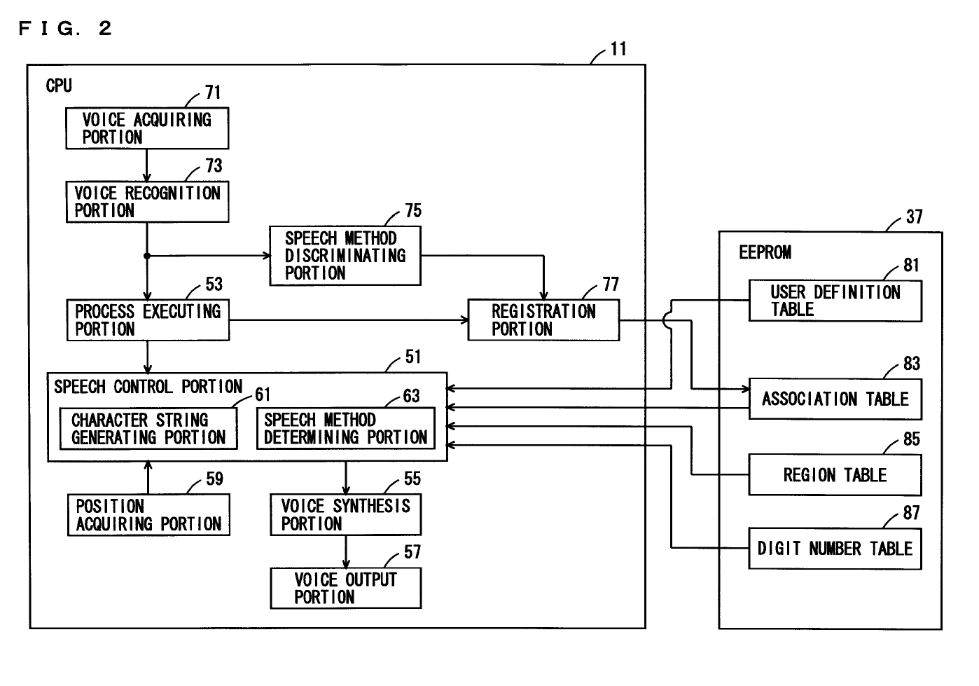

FIG. 2 is a functional block diagram showing, by way of example, functions of CPU 11 included in the navigation device. Referring to FIG. 2, CPU 11 includes: a process executing portion 53 which executes a process; a voice synthesis portion 55 which synthesizes a voice; a speech control portion 51 which controls voice synthesis portion 55; a voice output portion 57 which outputs a synthesized voice; a position acquiring portion 59 which acquires a current location; a voice acquiring portion 71 which acquires a voice; a voice recognition portion 73 which recognizes an acquired voice to output a text; a speech method discriminating portion 75 which discriminates a speech method on the basis of an output text; and a registration portion 77 which resisters a discriminated speech method.

Process executing portion 53 executes a navigation process. Specifically, it executes a process of supporting route guidance for a driver to drive a vehicle, a process of reading aloud map information stored in EEPROM 37, and the like. The process of supporting the route guidance includes, e.g., a process of searching for a route from the current location to a destination and displaying the searched route on a map, and a process of showing the travelling direction until the vehicle reaches the destination.

Process executing portion 53 outputs a result of the executed process. The result is made up of a set of data itself and a type of the data. The type includes address, telephone number, road information, and distance. For example, in the case of outputting facility information stored in EEPROM 37, process executing portion 53 outputs a set of the address of the facility and the type “address”, and also outputs a set of the telephone number of the facility and the type “telephone number”. In the case of outputting a current location, it outputs a set of the type “address” and the address of the current location. In the case of outputting a searched route, it outputs a set of the type “road information” and the road name indicating the road included in the route.

Position acquiring portion 59 acquires a current location on the basis of a signal that GPS receiver 13 receives from the satellite. Position acquiring portion 59 outputs the acquired current location to speech control portion 51. The current location includes, e.g., a latitude and a longitude. While position acquiring portion 59 may calculate the latitude and the longitude from the signal received from the satellite by GPS receiver 13, a radio communication circuit connected to a network such as the Internet may be provided, in which case the signal output from GPS receiver 13 may be transmitted to a server connected to the Internet, and the latitude and the longitude returned from the server may be received.

Speech control portion 51 includes a character string generating portion 61 and a speech method determining portion 63. Character string generating portion 61 generates a character string on the basis of the data input from process executing portion 53, and outputs the generated character string to voice synthesis portion 55. For example, in the case where a set of the address indicating the current location and the type “address” is input from process executing portion 53, a character string: “Current location is near XX (house number) in OO (town name)” is generated. In the case where a set of the telephone number of a facility and the type “telephone number” is input from process executing portion 53, a character string: “Telephone number is XX-XXXX-XXXX” is generated.

Speech method determining portion 63 determines a speech method on the basis of the type input from process executing portion 53, and outputs the determined speech method to voice synthesis portion 55. Specifically, speech method determining portion 63 refers to a reference table stored in EEPROM 37 to determine a speech method that is defined by the reference table in correspondence with the type input from process executing portion 53. The reference table includes a user definition table 81, an association table 83, a region table 85, and a digit number table 87. User definition table 81, association table 83, region table 85, and digit number table 87 will now be described.

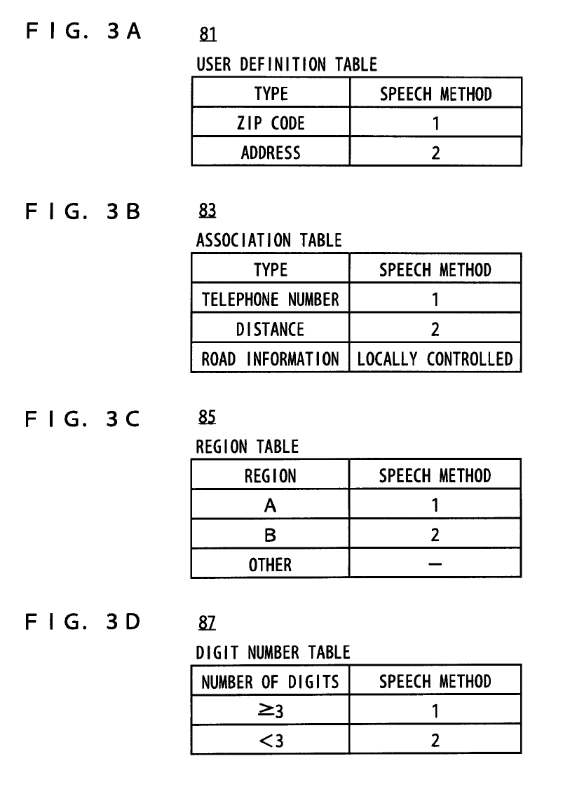

FIGS. 3A to 3D show examples of the reference tables. FIG. 3A shows an example of the user definition table, FIG. 3B shows an example of the association table, FIG. 3C shows an example of the region table, and FIG. 3D shows an example of the digit number table. Referring to FIG. 3A, user definition table 81 includes a user definition record which has been set in advance by a user of navigation device 1. The user definition record includes the fields of “type” and “speech method”. For example, a speech method “1” is defined for the type “zip code”, and a speech method “2” is defined for the type “address”. The speech method “1” refers to a speech method in which the numeral is read aloud as individual digits. The speech method “2” refers to a speech method in which the numeral is read aloud as a full number. In the user definition table shown in FIG. 3A, the speech method of reading aloud the numeral as individual digits is set for the type “zip code”, and the speech method of reading aloud the numeral as a full number is set for the type “address”.

Referring to FIG. 3B, the association table includes an association record which associates a type with a speech method. The association record includes the fields of “type” and “speech method”. An association record is generated when a user inputs voice data into navigation device 1 and is added to the association table, as will be described later. For example, the speech method “1” is associated with the type “telephone number”, and the speech method “2” is associated with the type “distance”. Further, in an association record, “locally restricted” is associated with a type of the character string of which speech method is locally restricted. More specifically, the speech method “locally restricted” is associated with the type “road information”. This allows the regional differences in speech method to be reflected to the speech method for the type “road information”.

Referring to FIG. 3C, region table 85 includes a region record in which a region and a speech method are associated with each other for the type that is locally restricted. Here, association table 83 shown in FIG. 3B defines that the type “road information” is locally restricted. Thus, in region table 85, a speech method to be used for speaking the road information in a certain region is defined. The region record includes the fields of “region” and “speech method”. For example, the speech method “1” is associated with a region “A”, the speech method “2” is associated with a region “B”, and no method is associated with “other” regions.

Referring to FIG. 3D, digit number table 87 includes a digit number record which associates the number of digits with a speech method. The digit number record includes the fields of “number of digits” and “speech method”. For example, the speech method “1” is associated with the number of digits of “three or more”, and the speech method “2” is associated with the number of digits of “less than three”. Thus, the numeral having three or more digits is associated with the speech method of reading aloud the numeral as individual digits, while the numeral having less than three digits is associated with the speech method of reading aloud the numeral as a full number.

Returning to FIG. 2, speech method determining portion 63 determines whether the speech method corresponding to the type input from process executing portion 53 has been defined in the user definition table. If it has been defined in the user definition table, speech method determining portion 63 determines the speech method as the defined one. In the case where the speech method corresponding to the type input from process executing portion 53 is not defined in user definition table 81, speech method determining portion 63 determines whether it has been defined in association table 83. If the type input from process executing portion 53 has been defined in association table 83, speech method determining portion 63 determines the speech method as the defined one. In the case where the type input from process executing portion 53 is “road information”, speech method determining portion 63 refers to region table 85. In this case, speech method determining portion 63 determines the region including the current location on the basis of the current location input from position acquiring portion 59.

Then, speech method determining portion 63 determines the speech method as the one that is associated with the determined region in the region table. In the case where region table 85 does not include any region record including the determined region, speech method determining portion 63 does not determine the speech method. In the case of not determining the speech method by referring to region table 85, speech method determining portion 63 refers to digit number table 87. It then determines the speech method as the one that is associated in digit number table 87 with the number of digits in the numeral that is expressed by the character string. When the numeral has three or more digits, speech method determining portion 63 determines the speech method as the one in which individual digits are read aloud one by one, while when the numeral has less than three digits, speech method determining portion 63 determines the speech method as the one in which the numeral is read aloud as a full number. Speech method determining portion 63 outputs the determined speech method to voice synthesis portion 55.

Voice synthesis portion 15 synthesizes a voice from the character string input from character string generating portion 61, and outputs the voice data to voice output portion 57. In the case where the character string input from character string generating portion 61 includes a numeral, voice synthesis portion 55 synthesizes a voice in accordance with the speech method input from speech method determining portion 63.

Voice output portion 57 outputs the voice data input from voice synthesis portion 55 to speaker 31. As a result, the voice data synthesized by voice synthesis portion 55 is output from speaker 31.

Voice acquiring portion 71 is connected with microphone 29, and acquires voice data that microphone 29 collects and outputs. Voice acquiring portion 71 outputs the acquired voice data to voice recognition portion 73. Voice recognition portion 73 analyzes the input voice data, and converts the voice data into a character string. Voice recognition portion 73 outputs the character string retrieved from the voice data, to process executing portion 53 and speech method discriminating portion 75. In process executing portion 53, the input character string is used for executing a process.

For example, in the case where the character string indicates a command, process executing portion 53 carries out a process in accordance with the command. In the case where process executing portion 53 executes a process of registering data, it adds the input character string to data at a registration destination for storage. At this time, a user may designate the registration destination by inputting a command as a voice via microphone 29 or by using operation keys 39. Process executing portion 53 outputs to registration portion 77 the type that is determined in accordance with the process being executed. For example, in the case where process executing portion 53 performs a process of setting a destination, the character string input as the destination should be an address. Thus, process executing portion 53 outputs “address” as the type. In the case where the destination is expressed by road information, it outputs “road information” as the type. In the case where process executing portion 53 performs a process of registering facility information, the facility name, address, and telephone number may be input. Process executing portion 53 outputs the type “address” when the address is input, and outputs the type “telephone number” when the telephone number is input.

Registration portion 77 generates an association record in which the type input from process executing portion 53 is associated with the speech method input from speech method discriminating portion 75, and adds the generated record to association table 83 for storage. As such, when a user of navigation device 1 performs an operation of inputting a voice command or data to navigation device 1, a new association record is generated and stored in association table 83. The association record is stored in association table 83 even if the user does not newly generate user definition table 81. This eliminates the need for the user to operate operation keys 39, for example, in order to generate user definition table 81.

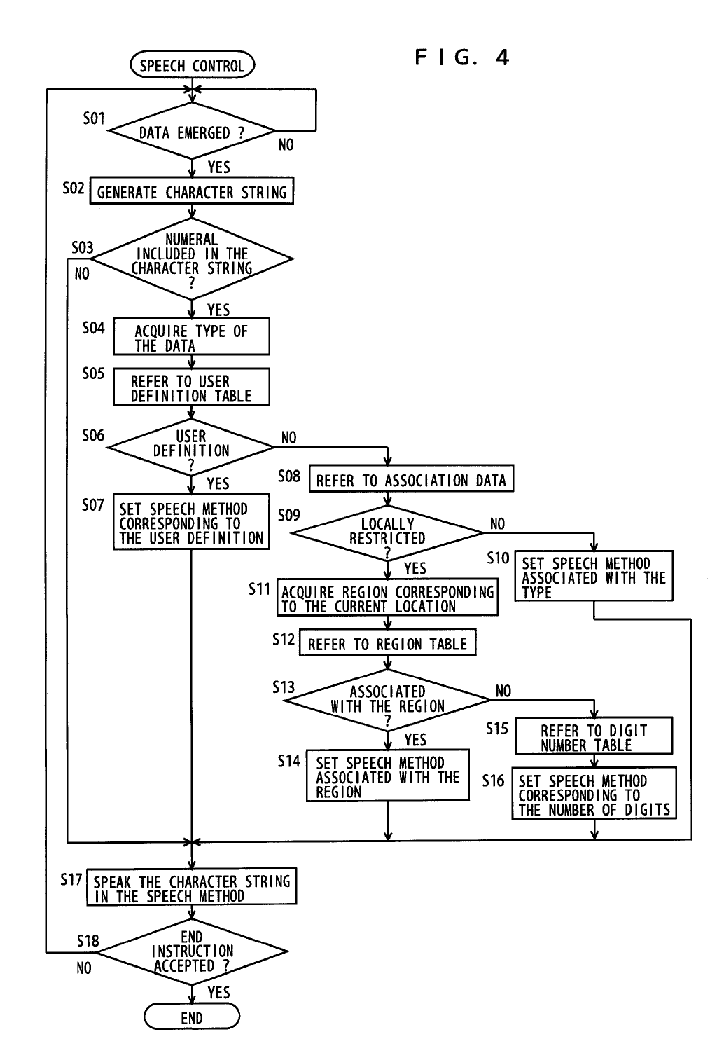

FIG. 4 is a flowchart illustrating, by way of example, a flow of a speech control process. The speech control process is carried out by CPU 11 as CPU 11 executes a speech control program. Referring to FIG. 4, CPU 11 determines whether data to be output as a voice has emerged (step S01). CPU 11 is in a standby mode until such data emerges (NO in step S01), and once the data has emerged, the process proceeds to step S02. In step S02, CPU 11 generates a character string to be output as a voice on the basis of the emerged data. It then determines whether the generated character string includes a numeral (step S03). If the character string includes a numeral, the process proceeds to step S04; otherwise, the process proceeds to step S17.

In step S04, the type of the data is acquired. Together with the data emerged in step S01, the type of that data is acquired on the basis of the process in which the data was generated. Specifically, when the process is for outputting an address, the type “address” is acquired, and when the process is for outputting a telephone number, the type “telephone number” is acquired. When the process is for outputting road information, the type “road information” is acquired, and when the process is for outputting a distance, the type “distance” is acquired.

In the following step S05, user definition table 81 stored in EEPROM 37 is referred to. It is determined whether the user definition records in user definition table 81 include a user definition record having the type acquired in step S04 set in the “type” field (step S06). If there is such a user definition record, the process proceeds to step S07; otherwise, the process proceeds to step S08. In step S07, from the user definition record including the type acquired in step S04, the speech method that is associated with the type is acquired, and the acquired speech method is set as the speech method for use in speaking the character string. The process then proceeds to step S17. In step S17, the character string is vocalized in the set speech method. The numeral corresponding to the type defined by the user is spoken in the speech method defined by the user, whereby the numeral can be spoken in a manner readily comprehensible to the user.

On the other hand, in step S08, association table 83 stored in EEPROM 37 is referred to. Specifically, of the association records included in association table 83, an association record having the type acquired in step S04 set in the “type” field is extracted. It is then determined whether the speech method is locally restricted (step S09). It is determined whether “locally restricted” has been set in the “speech method” field in the extracted association record. If “locally restricted” has been set, the process proceeds to step S11; otherwise, the process proceeds to step S10.

In step S10, the speech method that is set in the “speech method” field in the association record extracted in step S08 is set as the speech method for use in speaking the character string, and the process proceeds to step S17. In step S17, the character string is spoken in the set speech method. An association record included in association table 83 is generated on the basis of the speech method which was used by the user when the user input a voice into navigation device 1, as will be described later. Accordingly, the character string can be spoken in the same speech method as that the user had used when speaking the character string. This ensures that the character string is spoken in a manner readily comprehensible to the user.

In step S11, the current location is acquired, and the region to which the current location belongs is acquired. Then, region table 85 stored in EEPROM 37 is referred to (step S12). It is determined whether a speech method has been associated with the region acquired in step S11 (step S13). Specifically, it is determined whether the region records in region table 85 include a region record that includes the region acquired in step S11. If there is such a region record, it is determined that a speech method has been associated, and the process proceeds to step S14; otherwise, the process proceeds to step S15. In step S14, the speech method associated with the region is set as the speech method for use in speaking the character string, and the process proceeds to step S17. In step S17, the character string is spoken in the set speech method. The region record included in region table 85 defines the speech method specific to the region, so that the numeral is spoken in a manner according to the region to which the current location belongs. This allows the user to know a unique way of reading that is specific to the region.

In step S15, digit number table 87 stored in EEPROM 37 is referred to. Of the digit number records included in digit number table 87, a digit number record in which the number of digits of the numeral included in the character string generated in step S02 has been set in the “number of digits” field is extracted, and the speech method set in the “speech method” field in the extracted digit number record is acquired. The speech method associated with the number of digits is set as the speech method for use in speaking the character string (step S16), and the process proceeds to step S17. In step S17, the character string is spoken in the set speech method. In the digit number records included in digit number table 87, the numeral having three or more digits is associated with the speech method of reading aloud the numeral as individual digits, while the numeral having less than three digits is associated with the speech method of reading aloud the numeral as a full number. Accordingly, the number having three or more digits is read aloud as individual digits, whereas the numeral having less than three digits is read aloud as a full number. This ensures that the numerals are spoken in a manner readily comprehensible to the user.

When the speech is finished in step S17, the process proceeds to step S18. In step S18, it is determined whether an end instruction has been accepted. If the end instruction has been accepted, the speech control process is terminated; otherwise, the process returns to step S01.

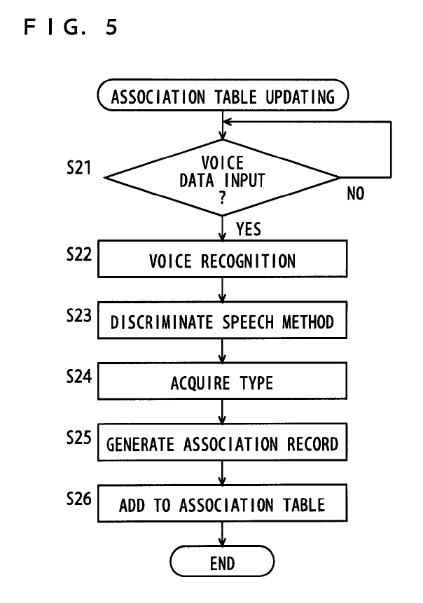

FIG. 5 is a flowchart illustrating, by way of example, a flow of an association table updating process. The association table updating process is carried out by CPU 11 as CPU 11 executes the speech control program. Referring to FIG. 5, CPU 11 determines whether voice data has been input. CPU 11 is in a standby mode until voice data is input (NO in step S21), and once the voice data is input, the process proceeds to step S22.

In step S22, the input voice data is subjected to voice recognition so as to be converted into a character string as text data. In the following step S23, the speech method is discriminated. For example, whether the voice data input is “one zero zero” or “one hundred”, it is converted into a character string “100”. However, from the voice data “one zero zero”, the speech method of speaking the numeral as individual digits is discriminated, while from the voice data “one hundred”, the speech method of speaking the numeral as a full number is discriminated.

In step S24, the type corresponding to that character string is acquired on the basis of the process that is executed in accordance with the character string that was voice-recognized in step S22. For example, in the case where the process of storing the character string as an “address” is to be executed, the type “address” is acquired. When the process of storing the character string as a telephone number is to be executed, the type “telephone number” is acquired. When the process of storing the character string as road information is to be executed, the type “road information” is acquired. When the process of storing the character string as a distance between two points is to be executed, the type “distance” is acquired.

In step S25, an association record is generated in which the type acquired in step S24 is associated with the speech method discriminated in step S23. The generated association record is additionally stored in association table 83 that is stored in EEPROM 37 (step S26).

In the case where the user inputs a voice for registration of data, the speech method the user used to speak the character string is stored in association with the type of the character string that was voice-input. This allows a character string of the same type as that spoken by the user to be spoken in the same speech method as that the user had used. As a result, the character strings can be spoken in a manner readily comprehensible to the user.

As described above, navigation device 1 according to the present embodiment stores user definition table 81, association table 83, and region table 85 in EEPROM 37 in advance. A character string to be output as a voice is generated on the basis of a set of data that is output from process executing portion 53 as it executes a process and a type of that data, and the generated character string is spoken in a speech method that is associated with the type of the data in user definition table 81, association table 83, or region table 85. As a result, the character string is spoken in the speech method predetermined for the type of the data, whereby the numeral can be spoken in a manner readily comprehensible to the user.

In the case where a user inputs data as a voice for registration of the data or other purposes, the voice is recognized, and the speech method of the voice is discriminated. An association record is then generated in which the type that is determined in accordance with the process to be executed on the basis of the recognized character string is associated with the discriminated speech method, and the generated association record is additionally stored in association table 83. As a result, a character string of the same type as the one spoken by the user can be spoken in the same speech method as the one used by the user.

While navigation device 1 has been described as an example of the speech device in the above embodiment, the speech device may be any device having the voice synthesis function, which may be, e.g., a mobile phone, a mobile communication terminal such as a personal digital assistant (PDA), or a personal computer.

Furthermore, the present invention may of course be understood as a speech control method for causing navigation device 1 to execute the processing shown in FIG. 4 or 5, or as a speech control program for causing a computer to carry out the speech control method.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### APPENDIX

(1) The speech device according to claim 1, wherein said process executing means executes a navigation process.

1. A speech device comprising:
speech portion, in the case where a given character string includes a numeral made up of a plurality of digits, for speaking said numeral in either a first speech method in which the individual digits of said numeral are read aloud one by one or a second speech method in which said numeral is read aloud as a full number;
associating portion to associate a type of a character string with either said first speech method or said second speech method;
process executing portion to execute a predetermined process to thereby output data; and
speech control means for generating a character string on the basis of said output data and causing said speech portion to speak said generated character string in one of said first and second speech methods that is associated with the type of said output data.

2. The speech device according to claim 1, further comprising:
voice acquiring portion to acquire a voice;
voice recognizing portion to recognize said acquired voice to output a character string; and
speech method discriminating portion, in the case where said output character string includes a numeral, for discriminating one of said first and second speech methods; wherein
said process executing portion executes a process that is based on said character string being output, and
said associating portion includes registration portion to associate the type of said character string that is determined on the basis of the process executed by said process executing portion with a discrimination result by said speech method discriminating portion.

3. The speech device according to claim 1, wherein said process executing portion executes a navigation process.

4. A speech device comprising:
speech portion, in the case where a given character string includes a numeral made up of a plurality of digits, for speaking said numeral in either a first speech method in which the individual digits of said numeral are read aloud one by one or a second speech method in which said numeral is read aloud as a full number;
determining portion to determine one of said first and second speech methods on the basis of the number of digits in a numeral included in a character string; and
speech control portion to cause said speech portion to speak the numeral in said determined one of said first and second speech methods.

5. A computer-readable recording medium storing therein a speech control program, the program causing a computer to execute the steps of:
associating either a first speech method in which a numeral made up of a plurality of digits is read aloud as individual digits or a second speech method in which a numeral made up of a plurality of digits is read aloud as a full number with a type of a character string;
outputting data by executing a predetermined process;
generating a character string on the basis of said output data; and
speaking said generated character string in one of said first and second speech methods that is associated with the type of said output data.

6. The computer-readable recording medium storing therein the speech control program according to claim 5, the program causing the computer to further execute the steps of:
acquiring a voice;
recognizing said acquired voice to output a character string; and
in the case where said output character string includes a numeral, discriminating one of said first and second speech methods; wherein
said step of outputting data includes the step of executing a process that is based on said character string being output, and
said associating step includes the step of associating the type of said character string that is determined on the basis of the process executed in said step of outputting data with a discrimination result in said discriminating step.

7. The computer-readable recording medium storing therein the speech control program according to claim 5, wherein said step of outputting data includes the step of executing a navigation process.

8. A computer-readable recording medium storing therein a speech control program, the program causing a computer to execute the steps of:
speaking a numeral made up of a plurality of digits in a first speech method in which the individual digits of the numeral are read aloud one by one;
speaking a numeral made up of a plurality of digits in a second speech method in which the numeral is read aloud as a full number;
determining one of said first and second speech methods on the basis of the number of digits in a numeral included in a character string; and
in the case where a given character string includes a numeral made up of a plurality of digits, causing the character string to be spoken in said determined one of said first and second speech methods.

9. A speech control method comprising the steps of:
associating either a first speech method in which a numeral made up of a plurality of digits is read aloud as individual digits or a second speech method in which a numeral made up of a plurality of digits is read aloud as a full number with a type of a character string;
outputting data by executing a predetermined process;
generating a character string on the basis of said output data; and
speaking said generated character string in one of said first and second speech methods that is associated with the type of said output data.

10. The speech control method according to claim 9, further comprising the steps of:
acquiring a voice;
recognizing said acquired voice to output a character string; and
in the case where said output character string includes a numeral, discriminating one of said first and second speech methods; wherein
said step of outputting data includes the step of executing a process that is based on said character string being output, and
said associating step includes the step of associating the type of said character string that is determined on the basis of the process executed in said step of outputting data with a discrimination result in said discriminating step.

11. The speech control method according to claim 9, wherein said step of outputting data includes the step of executing a navigation process.

12. A speech control method comprising the steps of:
speaking a numeral made up of a plurality of digits in a first speech method in which the individual digits of the numeral are read aloud one by one;
speaking a numeral made up of a plurality of digits in a second speech method in which the numeral is read aloud as a full number;
determining one of said first and second speech methods on the basis of the number of digits in a numeral included in a character string; and
in the case where a given character string includes a numeral made up of a plurality of digits, causing the character string to be spoken in said determined one of said first and second speech methods.
